(19) United States
(12) Patent Application Publication
(10) Pub. No.: US 2009/0276936 A1
(43) Pub. Date: Nov. 12, 2009

(54) SHAPE CHANGEABLE TEXTILE FABRIC

(75) Inventors: Manabu Makida, Fukui (JP); Hiroyuki Fukushima, Fukui (JP)

Correspondence Address: GREER, BURNS & CRAIN, 300 S WACKER DR, 25TH FLOOR, CHICAGO, IL, 60606, US

(73) Assignee: SEIREN CO., LTD., Fukui (JP)

(21) Appl. No.: 12/159,834

(22) PCT Filed: Jan. 17, 2007
(86) PCT No.: PCT/JP2007/051016

§ 371 Date: Jul. 1, 2008

(30) Foreign Application Priority Data
Jan. 17, 2006 (JP) 2006-9286
Jun. 23, 2006 (JP) 2006-173983

(51) Int. Cl. A41D 1/00; B32B 3/10

(52) U.S. Cl. 2/69; 428/196

(57) ABSTRACT

A waterproof layer is formed as necessary on one or both surfaces of a textile fabric and as an outermost layer there is formed a water-swelling layer comprising a water-insoluble water-swelling resin applied in a pattern form.

### FIELD OF THE INVENTION

The present invention relates to a textile fabric having comfortableness and suitable for use in the field of clothes such as, for example, inner wear, sports wear and rain coat. Particularly, the present invention is concerned with a textile fabric which, in a water (e.g., sweat) absorbed state thereof, affords excellent wearing comfort without sticking on the skin surface and with little sticky feeling.

### BACKGROUND OF THE INVENTION

Developments of various textile fabrics having functionality have heretofore been conducted and new commodities produced by combining fibrous materials, fabric structures and functional post-processings are available on the market.

Above all, a large number of moisture-permeating waterproof fabrics have been developed to eliminate sticky feeling and stuffy feeling both caused by sweating.

For example, in JP 2005-023431A, JP 2005-146497A and JP 2002-180323A there are proposed moisture-permeating waterproof fabrics. These fabrics are each produced by using two types of polymers different in crimp rate under the influence of humidity, spinning the polymers side by side into yarn, and weaving or knitting the yarn into fabric. When humidity becomes high, the woven or knitted texture of the fabric opens largely due to a difference in crimp rate between the polymers, whereby the air permeability is improved.

For example, however, when sweating occurs in a large amount, it is difficult to eliminate sticky or stuffy feeling and maintain a satisfactory wearing comfort.

### DISCLOSURE OF THE INVENTION

### Object of the Invention

It is an object of the present invention to solve the above-mentioned problem of the prior art and provide fabric which is less sticky when absorbing water such as sweat, superior in feeling, and whose shape changes in a wet state.

### SUMMARY OF THE INVENTION

The present invention firstly resides in a shape changeable textile fabric having a water swelling layer as an outermost layer on at least one surface thereof, the water swelling layer comprising a water-insoluble water-swelling resin applied in a pattern form.

The present invention secondly resides in the above shape changeable textile fabric having a waterproof continuous layer between the textile fabric and the outermost layer, the waterproof continuous layer comprising resin not having a water-swelling property.

The present invention thirdly resides in the above first or second shape changeable textile fabric wherein the pattern of the outermost layer is a uniform pattern.

The present invention fourthly resides in any of the above first to third shape changeable textile fabrics wherein the patter of the outermost layer is a sea-island pattern or a parallel line pattern.

The present invention fifthly resides in any of the above first to fourth shape changeable fabrics wherein the thickness of the outermost layer is 1-300 μm.

The present invention sixthly resides in any of the above first to fifth shape changeable textile fabrics wherein a total area of the resin portion in the outermost layer relative to the textile fabric is 5-90%.

The present invention seventhly resides in any of the above first to sixth shape changeable textile fabrics wherein the degree of water swelling of the water-swelling resin is 5-100%.

The present invention eighthly resides in any of the above second to seventh shape changeable textile fabric wherein the waterproof continuous layer is a moisture-permeable waterproof continuous layer.

The present invention ninthly resides in clothing which comprises any of the above first to eighth shape changeable textile fabrics.

### BRIEF DESCRIPTION OF THE DRAWINGS

FIG. 1 is a schematic plan view showing an example of the shape changeable textile fabric of the present invention.

FIG. 2 is a schematic sectional view showing a change in absorption of the shape changeable textile fabric of the present invention.

In the drawings, the numeral 1 denotes a water-swelling resin, 2 a textile fabric, 3 a waterproof layer and 4 a concave/convex difference.

### EMBODIMENTS OF THE INVENTION

The present invention will be described in detail hereinunder.

The shape changeable textile fabric of the present invention is characterized by having a water-swelling layer as an outermost layer on one or both surfaces of the textile fabric, the water-swelling layer comprising a water-insoluble water-swelling resin arranged in a pattern form.

The material of the textile fabric used in the present invention is, for example, synthetic fiber such as polyester, nylon, acryl or polyvinyl alcohol, regenerated fiber such as rayon, natural fiber such as cotton, hemp, wool or silk, or a mixture or combination thereof, with no special limitation thereto. The textile fabric of the present invention may be in any form; for example, it may be in the form of woven, knitted or non-woven fabric.

As to the water-insoluble water-swelling resin used in the present invention, its water swelling degree is 5-100%, preferably 10-50%. If the water swelling degree is smaller than 5%, the shape change of the textile fabric will be small and there is a fear that the sticky feeling may not be eliminated. If the water swelling degree is larger than 100%, a three-dimensional change of the textile fabric will become too large or the resin in question is likely to fall off from the textile fabric in a water-absorbed state of the fabric, with consequent fear of wearing feel being impaired.

By a water swelling rate is meant a volume increase rate determined when the absorption of water reaches a saturated state in effect at room temperature (20° C.). It is usually represented in terms of a volume increase rate determined after immersion of a dry resin piece in 20° C. distilled water for 24 hours.

The water-insoluble water-swelling resin used in the present invention is substantially insoluble in water under a working environment and has a property of absorbing water and swelling in the presence of water. For example, there may be used any of starch-acrylic acid grafted resin, polyacrylate resin, polyvinyl alcohol resin, vinyl acetate-acrylate resin, isobutylene-maleic acid resin, poly-N-vinyl acetamide resin, polyether urethane resin, polyester urethane resin, polyester polyether urethane resin, and polycarbonate urethane resin. Particularly, polyether urethane resin is preferred in point of resin adherence, wear resistance and moisture permeability. As examples of polyether urethane resin, mention may be made of SANPLENE HMP-17A (a product of Sanyo Chemical Industries, Ltd.), HI-MUREN Y301-3 (a product of Dainichiseika Color & Chemicals Mfg. Co., Ltd.) and CRISVON S525 (a product of Dainippon Ink And Chemicals, Incorporated).

For the improvement of adherence it is preferable to add a crosslinking agent such as an isocyanate type-, carbodiimide type- or epoxy type- crosslinking agent to the water-insoluble water-swelling resin. Further, fine powders of inorganic or organic materials such as, for example, pigment, dye, surfactant, plasticizer, calcium carbonate, titanium oxide, colloidal silica, cellulose and protein may be added insofar as they do not impair the water-swelling property and wearing feel.

In the present invention, the water-insoluble water-swelling resin is applied in a pattern form (i.e., partially with respect to the entire surface area) as an outermost layer to one or both surfaces of the textile fabric directly or through another layer. The pattern is preferably a uniform pattern, especially a sea-island pattern (it is optional whether the water-insoluble water-swelling resin forms discontinuous islands or continuous sea), or a parallel lines-like pattern. As examples of island (dot) shapes in the sea-island pattern there are mentioned polygonal shapes such as triangular and quadrangular shapes, as well as circular and elliptic shapes. As examples of linear shapes in the parallel lines-like pattern (stripy pattern) there are mentioned straight line, curved line and polygonal line. Patter spacing (dot spacing, spacing of parallel lines) may be determined suitably, but is usually 1-30 mm, preferably 3-15 mm.

The thickness of the resin portion comprising the water-insoluble water-swelling resin is preferably 1-300 μm, more preferably 5-150 μm. If the resin portion thickness is smaller than 1 μm, the change in shape of the textile fabric will be small with consequent fear of sticky feeling being not eliminated. If it is larger than 300 μm, a sense of incongruity may occur when wearing the textile fabric or the resin in question may fall off easily from the textile fabric when the fabric absorbs water and swells.

An area ratio of the water-insoluble water-swelling resin portion relative to the surface area of the textile fabric is preferably 5-90%, more preferably 10-60%. If the area ratio is smaller than 5%, the change in shape of the textile fabric will be small and the sticky feeling may not be eliminated. If it is larger than 90%, there is a fear that a sense of incongruity may occur when wearing the fabric.

The water-insoluble water-swelling resin may be applied to the textile fabric, for example, by transfer, gravure coating, screen printing, or rotary printing, with gravure coating, screen printing and rotary printing being preferred.

By using the gravure coating method, screen printing method or rotary printing method it becomes possible to easily adjust the shape and thickness of the resin portion. More particularly, in the gravure coating method, screen printing method or rotary printing method, a predetermined shape is formed on a gravure roll, a screen printing board or a rotary printing board, whereby a resin portion having a predetermined pattern can be formed easily in the textile fabric. Besides, since it is possible to perform a continuous application of the resin, mass production becomes possible and thus the productivity is superior.

In a second aspect of the present invention, a waterproof continuous layer is applied onto one or both surfaces of the textile fabric and then the water-insoluble water-swelling resin described above is applied in a pattern form. This is for causing a change in shape due to a difference in water swelling rate between the waterproof layer and the water-swelling layer. Therefore, it is necessary that the resin which constitutes the waterproof layer should not possess a water-swelling property.

As examples of the resin forming the waterproof layer, not possessing a water-swelling property and employable in the present invention, mention may be made of polyester based urethane resin, polyether based urethane resin, polycarbonate based urethane resin, acrylic resin, synthetic rubber and polyvinyl chloride resin. Particularly, a microporous film containing urethane resin as a principal component and a porous-free film containing urethane resin having moisture permeability as a principal component are preferred. As examples of resin for the microporous film are mentioned such polyester based urethane resins as REZAMINE CU4555HV (a product of Dainichiseika Color & Chemicals Mfg. Co., Ltd) and CRISVON MP859 (a product of Dainippon Ink And Chemicals, Incorporated). As examples of the porous-free film are mentioned such polyether based urethane resins as CRISVON NYT-18 (a product of Dainippon Ink And Chemicals, Incorporated) and HI-MUREN NPU5 (a product of Dainichiseika Color & Chemicals Mfg. Co., Ltd.).

The resin used for the waterproof layer is substantially free of water-swelling property and by the waterproof layer is usually meant a layer which exhibits a waterproofness of 1000 mm or more as determined by the low water pressure process defined in JIS L 1092. A moisture-permeable waterproof layer is preferred. Particularly, one which exhibits a moisture permeability of 3000 g/m²·24 hr as determined by the calcium chloride method (A-1 method) defined in JIS L 1099 is preferred.

Application of the pattern-like water-swelling layer comprising the water-insoluble water-swelling resin onto the waterproof continuous layer can be done as described above. However, in case of providing the waterproof layer, it is preferable for the water-swelling layer to have a water-swelling rate of 5-50%, more preferably 10-30%.

If the water-swelling rate is smaller than 5%, the change in shape of the textile fabric is small and the area of contact with the skin is not decreased, with consequent fear of the sticky feeling being not eliminated. If it is larger than 50%, the adherence to the waterproof layer will be deteriorated and there is a fear that the water-swelling layer may become easier to fall off.

An area ratio of the water-swelling layer to the waterproof layer is preferably 10-80%, more preferably 20-60%. If the coating area is smaller than 10%, a stress difference based on a difference in swelling between both layers is difficult to occur and there is a fear that a change in shape may not occur or the ratio of convex portions formed by a change in shape may be small, resulting in the textile fabric coming into contact with the skin and the sticky feeling being unable to be reduced. If the coating area exceeds 80%, the area of contact with the skin cannot be decreased because of too many convex portions, resulting in not only the sticky feeling being unable to be reduced but also a fear that feeling may become hard.

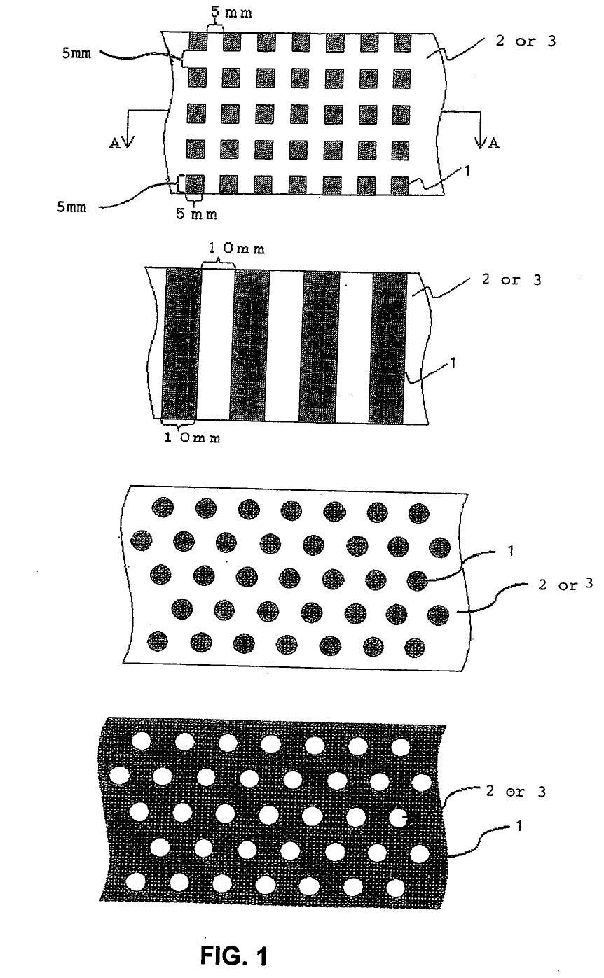

FIG. 1 is a schematic plan view showing a typical example of an outermost layer in the shape changeable textile fabric of the present invention, wherein the numeral 1 denotes a water-insoluble water-swelling resin portion and the layer which underlies the resin portion 1 is a textile fabric 2 or waterproof layer 3.

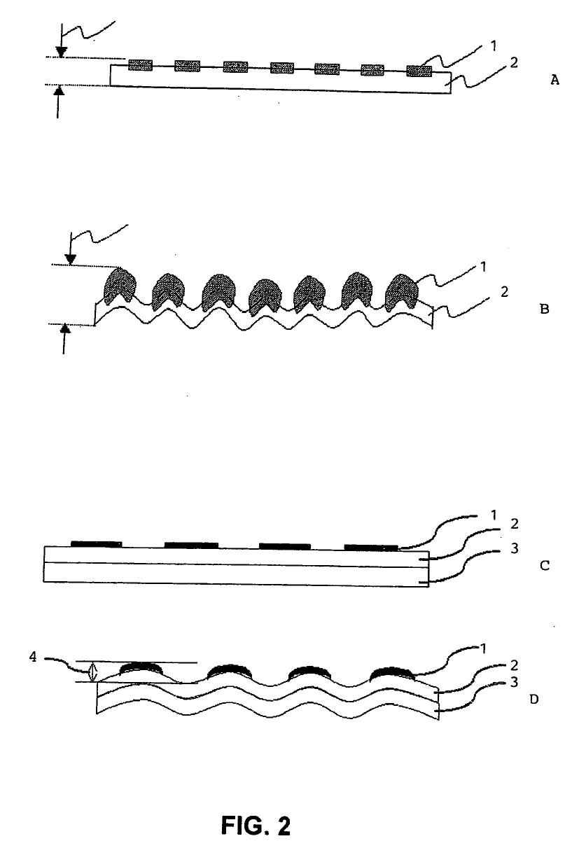

FIG. 2 is a schematic sectional view showing a dry state (A and C) and a water-swollen state (B and D) of the shape changeable textile fabric of the present invention. As shown in A (without the waterproof layer) and C (with the waterproof layer 2) of FIG. 2, the water-swelling resin 1 is partially formed in a pattern shape and it absorbs sweat or moisture condensate resulting from the wearer taking exercise, then swells. However, a stress difference occurs in the underlying textile fabric or waterproof layer and pushes the textile fabric or waterproof layer, so that the shape changeable fabric undergoes a change in shape as shown in B (without the waterproof layer) and D (with the waterproof layer) of FIG. 2. In a dry condition, the water-swelling resin shrinks, resulting in the stress difference from the underlying layer becoming extinguished and the shape substantially reverting to the original shape.

### EXAMPLES

The present invention will be described below in more detail by way of examples thereof, but is not limited to the following examples. In the following examples, characteristic values were measured by the following methods.

### (1) Coating Area Ratio (%) of the Water-Swelling Resin to the Waterproof Layer

A test cloth surface with both waterproof layer and water-swelling resin layer stacked thereon was observed using a microscope and the ratio of area of the water-swelling resin layer to the whole area was used as a coating area ratio.

### (2) Water-Swelling Rate (%) of the Water-Swelling Resin

A resin piece was immersed in 20° C. distilled water for 24 hours, then taken out and its water-swelling rate was calculated in terms of a volume increase rate.

### (3) Thickness of the Water-Swelling Resin Portion (μm)

Thickness was measured by observing a section of the resin portion having a water-swelling property with use of a microscope (DIGITALMAICROSCOPE VHX-200, a product of KEYENCE).

### (4) Resistance to Water Pressure (Kpa)

Determined according to the high water pressure process defined in JIC L 1092.

### (5) Concave/Convex Difference

Test cloths obtained in Examples and Comparative Examples were each immersed in an aqueous solution containing 0.01% of Emulgen 910 (a nonionic surfactant, a product of Kao Corp.) for 10 minutes, then taken out and water drops were removed using filter paper, thereafter a concave/convex difference was measured using a microscope (DIGITALMALCROSCOPE VHX-200, a product of KEYENCE).

### (6) Contact Area Ratio (%)

Test cloth was cut in the size of 10 cm×10 cm and 0.5 ml of an aqueous solution containing 0.01% of Emulgen 910 was dropped to the test cloth, then the test cloth was held down with a 10 cm×10 cm glass plate (weight: 70 g) for 5 minutes and thereafter a contact area ratio was calculated in terms of a wet area between the waterproof cloth resin surface and the glass plate. The smaller the numerical value, the less contact with the skin and the more comfortable.

### (7) Feeling

Feeling of each test cloth was evaluated in the following three stages by a panel's organoleptic test:
O: There is no change in feeling as compared with untreated cloth and feeling is good.
Δ: There is a slight change in feeling as compared with untreated cloth, but feeling is almost good.
x: There is a conspicuous change in feeling as Compared with untreated cloth and feeling is bad.

### (8) Wearing Comfort (Sticky Feeling)

Test cloth was cut in the size of 10 cm×10 cm and 0.5 ml of an aqueous solution containing 0.01% of Emulgen (a nonionic surfactant, a product of Kao Corp.) was dropped to test cloth, then the test cloth was held down with a 10 cm×10 cm glass plate (weight: 70 g) for 5 minutes, thereafter the resin surface was brought into contact with a human's upper arm portion and the sense of touch was evaluated in the following three stages:

O: Weak sticky feeling, comfortable.

Δ: Sticky feeling, but somewhat comfortable.

x: Strong sticky feeling, uncomfortable.

### Example 1

Circular knitted fabric comprising 84 dtex/36 f polyester yarn and 110 dtex/24 f polyester yarn was subjected in a conventional manner to scouring, subsequent presetting, dyeing and water absorption. Thereafter, heat treatment was performed at 150° C. for 1 minute.

Then, with a gravure roll having a dot pattern (dot size: 5 mm square, dot spacing: 10 mm), a water-swelling resin of the following Formulation 1 was applied to the fabric and heat treatment was performed at 130° C. for 1 minute. Next, as a post-treatment, soaping was conducted suing 50° C. warm water. After dehydration, heat treatment was conducted at 150° C. for 1 minute to afford a shape changeable textile fabric.

### Formulation 1

| | |
|---|---|
| HI-MUREN Y-611-124 | 100 parts by weight |
| (a solvent type polyether based urethane resin, solids | |
| content 25%, a product of Dainichiseika Color & | |
| Chemicals Mfg. Co., Ltd.) | |
| N,N-dimethylformamide | 40 parts by weight |

### Example 2

Plain weave fabric comprising 110 dtex/24 f polyester yarn as warp and 84 dtex/36 f polyester yarn as weft was subjected to scouring, presetting, dyeing and water absorption in the same way as in Example 1, followed by dry heat treatment. Then, with a gravure roll having a line pattern (line width: 10 mm, line spacing: 10 mm), the water-swelling resin of the above Formulation 1 was applied to the fabric and heat treatment was performed at 130° C. for 1 minute. Next, as a post-treatment, soaping was conducted using 50° C. warm water, followed by dehydration and subsequent heat treatment at 150° C. for 1 minute to afford a shape changeable textile fabric. Evaluation results are shown in Table 1.

### Example 3

Taffeta fabric comprising 100% grey yarn of 78 dtex/68 f nylon fiber was subjected to scouring, presetting and dye fixing by conventional methods, followed by heat treatment at 150° C. for 1 minute. Then, with a gravure roll having a dot pattern (dot size: 5 mm square, dot spacing: 10 mm), a water-swelling resin of the following Formulation 2 was applied to the fabric and heat treatment was conducted at 130° C. for 1 minute. Next, as a post-treatment, soaping was performed using 50° C. warm water, followed by dehydration and subsequent heat treatment at 150° C. for 1 minute to afford a shape changeable textile fabric. Evaluation results are shown in Table 1.

### Formulation 2

| | |
|---|---|
| HI-MUREN Y-611-124 | 60 parts by weight |
| (a solvent type polyether based urethane resin, solids | |
| content 25%, a product of Dainichiseika Color & | |
| Chemicals Mfg. Co., Ltd.) | |
| HI-MUREN NPU5 | 40 parts by weight |
| (a solvent type polyether based urethane resin, solids | |
| content 25%, a product of Dainichiseika Colour & | |
| Chemicals Mfg. Co., Ltd.) | |
| N,N-dimethylformamide | 40 parts by weight |

### Example 4

The same circular-knitted polyester yarn fabric as in Example 1 was subjected to scouring, presetting, dyeing, water absorption and dry heat treatment in the same way as in Example 1. Then, with a gravure roll having a dot pattern (dot size: 5 mm square, dot spacing: 5 mm), the water-swelling resin of the above Formulation 1 was applied to the fabric and heat treatment was performed at 130° C. for 1 minute. Next, as a post-treatment, soaping was conducted using 50° C. warm water, followed by dehydration and subsequent heat treatment at 150° C. for 1 minute to afford a shape changeable textile fabric. Evaluation results are shown in Table 1.

### Example 5

The same circular-knitted polyester yarn fabric as in Example 1 was subjected to scouring, presetting, dyeing, water absorption and dry heat treatment in the same way as in Example 1. Then, with a screen printing board having a dot pattern (dot size: 5 mm square, dot spacing: 10 mm), a water-swelling resin of the following Formulation 3 was applied to the fabric and heat treatment was performed at 130° C. for 1 minute. Next, as a post-treatment, soaping was conduced using 50° C. warm water, followed by dehydration and subsequent heat treatment at 150° C. for 1 minute to afford a shape changeable textile fabric. Evaluation results are shown in Table 1.

### Formulation 3

| | |
|---|---|
| UPM-212NH | 100 parts by weight |
| (an aqueous polyether based urethane resin, solids | |
| content 30%, a product of Ipposha Oil Industries | |
| Co., Ltd.) | |
| M-2005A | 2 parts by weight |
| (a high molecular weight polyoxyethylene | |
| derivative, solids content 30%, a product of | |
| Dai-ichi Kogyo Seiyaku Co., Ltd.) | |

### Example 6

The same circular-knitted polyester yarn fabric as in Example 1 was subjected to scouring, presetting, dyeing, water absorption and dry heat treatment in the same way as in Example 1. Then, with a screen printing board having a line pattern (line width: 10 mm, line spacing: 10 mm), the water-swelling resin of the above Formulation 2 was applied to the fabric and heat treatment was performed at 130° C. for 1 minute. Next, as a post-treatment, soaping was conducted using 50° C. warm water, followed by dehydration and subsequent heat treatment at 150° C. for 1 minute to afford a shape changeable textile fabric. Evaluation results are shown in Table 1.

### Example 7

The same nylon yarn taffeta fabric as in Example 3 was subjected to scouring, presetting, dyeing, dye fixing and dry heat treatment in the same way as in Example 3. Then, with a screen printing board having a dot pattern (dot size: 5 mm square, dot spacing: 3 mm), a water-swelling resin of the following Formulation 4 was applied to the fabric and heat treatment was performed at 130° C. for 1 minute. Next, as a post-treatment, soaping was conducted using 50° C. warm water, followed by dehydration and subsequent heat treatment at 150° C. for 1 minute to afford a shape changeable textile fabric. Evaluation results are shown in Table 1.

### Formulation 4

| | |
|---|---|
| UPM-212NH | 70 parts by weight |
| (an aqueous polyether based urethane resin, solids | |
| content 20%, a product of Ipposha Oil Industries | |
| Co., Ltd.) | |
| Super Flex 860 | 30 parts by weight |
| (an aqueous polyester based urethane resin, solids | |
| content 40%, a product of Dai-ichi Kogyo Seiyaku | |
| Co., Ltd.) | |
| M-2005A | 2 parts by weight |
| (a high molecular weight polyoxyethylene | |
| derivative, solids content 30%, a product of Dai- | |
| ichi Kogyo Seiyaku Co., Ltd.) | |

### Comparative Example 1

There was used the same circular-knitted polyester yarn fabric as in Example 1, which was subjected to scouring, presetting, dyeing, water absorption and dry heat treatment in the same way as in Example 1, provided the water-swelling resin was not applied to the fabric. Evaluation results are shown in Table 1.

### Comparative Example 2

There was used the same nylon yarn taffeta fabric as in Example 3, which was subjected to scouring, presetting, dyeing, dye fixing and dry heat treatment in the same way as in Example 3, provided the water-swelling resin was not applied to the fabric. Evaluation results are shown in Table 1.

### Comparative Example 3

There was used the same nylon yarn taffeta fabric as in Example 3, which was subjected to scouring, presetting, dyeing, dye fixing and dry heat treatment in the same way as in Example 3. Using a knife-on-bed, a water-swelling resin of the following Formula 5 was applied to the whole surface of the fabric and heat treatment was performed at 130° C. for 1 minute. Next, as a post-treatment, soaping was conducted using 50° C. warm water, followed by dehydration and subsequent heat treatment at 150° C. for 1 minute. Evaluation results are shown in Table 1.

### Formulation 5

| | |
|---|---|
| HI-MUREN Y-611-124 | 100 parts by weight |
| (a solvent type polyether based urethane resin, solids | |
| content 25%, a product of Dainichiseika Color & | |
| Chemicals Mfg. Co., Ltd.) | |
| N,N-dimethylformamide | 20 parts by weight |

### Comparative Example 4

There was used the same circular-knitted polyester yarn fabric as in Example 1, which was subjected to scouring, presetting, dyeing, water absorption and dry heat treatment in the same way as in Example 1. With a gravure roll having a dot pattern (dot size: 5 mm square, dot spacing: 10 mm), a water-swelling resin of the following Formulation 6 was applied to the fabric and heat treatment was performed at 130° C. for 1 minute. Next, as a post-treatment, soaping was conduced using 50° C. warm water, followed by dehydration and subsequent heat treatment at 150° C. for 1 minute. Evaluation results are shown in Table 1.

### Formulation 6

| | |
|---|---|
| HI-MUREN NPU5 | 100 parts by weight |
| (a solvent type polyether based urethane resin, solids | |
| content 25%, a product of Dainichiseika Color & | |
| Chemicals Mfg. Co., Ltd.) | |
| N,N-dimethylformamide | 40 parts by weight |

### Example 8

Nylon taffeta obtained by using nylon multifilament 78 dtex/68 filaments for both warp and weft was subjected to scouring and dyeing in a conventional manner. Thereafter, padding was performed at a squeeze ratio of 50% using an aqueous solution containing 3 wt % of ASAHIGUARD AG 7000 (a fluoric water repellent, a product of Meisei Chemical Works, Ltd.), followed by drying at 120° C. for 1 minute and subsequent heat treatment at 170° C. for 60 seconds. Further, calendaring was performed under the conditions of temperature 170° C. and pressure 30 kgf/cm².

Next, a polyurethane resin solution of the composition shown in the following Formulation 7 was applied in an amount of 80 g/m² to the above calendered surface with use of a knife-over-roll coater. Thereafter, the fabric was immersed in 20° C. water for 120 minutes, allowing the resin to coagulate and then washed in 50° C. warm water for 10 minutes, followed by drying at 130° C., to form a microporous waterproof layer on one surface of the nylon taffeta.

Next, with a gravure roll having a dot pattern (pattern shape: a circle of 4 mm dia., pattern spacing: 4 mm), a resin solution of the composition shown in the following Formulation 7 was applied to the fabric at a pattern depth of 300 μm and heat treatment was performed at 130° C. for 1 minute to afford a shape changeable textile fabric. Evaluation results are shown in Table 2.

### Formulation 7 (a Resin Solution for a Microporous Waterproof Layer)

| | |
|---|---|
| REZAMINE CU4550HV | 100 parts by weight |
| (an ester based polyurethane resin, a product of | |
| Dainichiseika Color & Chemicals Mfg. Co., Ltd.) | |
| HAKUENKA CCR | 5 parts by weight |
| (calcium carbonate, a product of Shiraishi Kogyo | |
| Kaisha, Ltd.) | |
| COLONATE HX | 1 part by weight |
| (an isocyanate type crosslinking agent, a product | |
| of Nippon Polyurethane Co., Ltd.) | |
| N,N-dimethylformamide | 40 parts by weight |

### Formulation 8 (A Water-Absorbing/Swelling Resin Solution)

| | |
|---|---|
| HI-MUREN Y611-124 | 100 parts by weight |
| (a polyether based urethane resin, a product of | |
| Dainichiseika Color & Chemicals Mfg. Co., Ltd.) | |
| N, N-dimethylformamide | 50 parts by weight |

### Example 9

A shape changeable textile fabric was produced in the same way as in Example 8 except that the pattern of the water-swelling resin portion was changed to a circular pattern of 4 mm dia. with a pattern spacing of 6 mm.

### Example 10

A shape changeable textile fabric was produced in the same way as in Example 8 except that the pattern of the water-swelling resin portion was changed to the inverted layout pattern (inverted spotted pattern) adopted in Example 9.

### Example 11

A shape changeable textile fabric was produced in the same way as in Example 8 except that the water-swelling resin solution was changed to a solution of the following Formulation 9.

### Formulation 9 (a Resin Solution Having a Water Absorbing/Swelling Property)

| | |
|---|---|
| HI-MUREN Y301-3 | 100 parts by weight |
| (a polyether based urethane resin, a product of | |
| Dainichiseika Color & Chemicals Mfg. Co., Ltd.) | |
| Isopropyl alcohol | 50 parts by weight |

### Example 12

A shape changeable textile fabric was produced in the same way as in Example 8 except that the gravure pattern depth was changed to 80 μm at the time of application of the water-swelling resin.

### Comparative Example 5

Processed fabric was obtained in the same way as in Example 8 except that the coating resin solution was changed to a solution of the following Formulation 10.

### Formulation 10

| | |
|---|---|
| HI-MUREN NPU5 | 100 parts by weight |
| (a polyether urethane resin, a product of | |
| Dainichiseika Color & Chemicals Mfg. Co., Ltd.) | |
| Isopropyl alcohol | 50 parts by weight |

### Comparative Example 6

Processed fabric was obtained in the same way as in Example 8 except that the resin coating method was changed to the knife coating method and the resin solution was applied to the whole surface of the waterproof layer.

### Comparative Example 7

Processed fabric was obtained in the same way as in Example 8 except that the coating resin solution was changed to a solution of the following Formulation 11.

| | |
|---|---|
| Super Flex 610 | 100 parts by weight |
| (a polyester based urethane resin, a product of | |
| Dai-ichi Kogyo Seiyaku Co., Ltd.) | |
| M-2005A | 2 parts by weight |
| (a polyoxyethylene type thickener, a product of | |
| Dai-ichi Kogyo Seiyaku Co., Ltd.) | |

### Comparative Example 8

An adhesive solution shown in the following Formulation 12 was applied in a dot shape at a coating area of 30% onto the microporous waterproof layer fabricated in Example 8, followed by drying at 100° C. Thereafter, nylon 22 dtex half tricot cloth was laminated to the coated surface to afford fabric.

### Formulation 12 (An Adhesive Resin Solution)

| | |
|---|---|
| CRISVON 4365t | 100 parts by weight |
| (a polyether based polyurethane adhesive, a | |
| product of Dainippon Ink And Chemicals, | |
| Incorporated) | |
| BURNOCK DN-950 | 5 parts by weight |
| (a crosslinking agent, a product of Dainippon | |
| Ink And Chemicals, Incorporated) | |
| CRISVON Accel T | 1 part by weight |
| (a crosslinking accelerator, a product of | |
| Dainippon Ink And Chemcials, Incorprated) | |
| Toluene | 40 parts by weight |

TABLE 1

| | | Exam- | Exam- | Exam- | Exam- | Exam- | Exam- | Exam- | Comparative | Comparative | Comparative | Comparative |
|---|---|---|---|---|---|---|---|---|---|---|---|---|
| | | ple 1 | ple 2 | ple 3 | ple 4 | ple 5 | ple 6 | ple 7 | Example 1 | Example 2 | Example 3 | Example 4 |
| Water- | Volume | 86% | 86% | 33% | 86% | 91% | 91% | 23% | — | — | 86% | 0% |
| Swelling | Swell | | | | | | | | | | | |
| Resin | Coating | 25% | 50% | 25% | 15% | 25% | 50% | 40% | — | — | 100% | 25% |
| Portion | Area | | | | | | | | | | | |
| | Resin | 40 μm | 35 μm | 20 μm | 30 μm | 70 μm | 140 μm | 70 μm | — | — | 10 μm | 30 μm |
| | Portion | | | | | | | | | | | |
| | Thickness | | | | | | | | | | | |
| | Pattern | 5 mm | 10 mm | 5 mm | 5 mm | 5 mm | 10 mm | 5 mm | — | — | whole | 5 mm |
| | | square | line | square | square | square | line | square | | | surface | square |
| | | dot | | dot | dot | dot | | dot | | | coating | dot |

| | | | | | | | | | | | |
|---|---|---|---|---|---|---|---|---|---|---|---|
| Resistance to | — | — | — | — | — | — | — | — | — | — | — |
| Water Pressure | | | | | | | | | | | |
| Feeling | ◯ | ◯ | ◯ | ◯ | ◯ | Δ | ◯ | ◯ | ◯ | X | ◯ |
| Concave/Convex | 305 μm | 320 μm | 290 μm | 225 μm | 215 μm | 335 μm | 310 μm | 25 μm | 0 μm | 0 μm | 30 μm |
| Difference | | | | | | | | | | | |
| Contact Area Ratio | 54% | 42% | 57% | 60% | 62% | 32% | 45% | 95% | 100% | 100% | 95% |
| Wearing Comfort | ◯ | ◯ | ◯ | ◯ | ◯ | ◯ | ◯ | X | X | X | X |

TABLE 2

| | | Exam- | | Exam- | | Exam- | | Exam- | | Exam- | | Comparative | | Comparative | | Comparative | | Comparative |
|---|---|---|---|---|---|---|---|---|---|---|---|---|---|---|---|---|---|---|
| | | ple 8 | | ple 9 | | ple 10 | | ple 11 | | ple 12 | | Example 5 | | Example 6 | | Example 7 | | Example 8 |
| Water- | Volume | 86% | | 86% | | 86% | | 48% | | 86% | | 6% | | 86% | | 325% | | |
| Swell- | Swell | | | | | | | | | | | | | | | | | |
| ing | Coating | 23% | | 15% | | 77% | | 23% | | 23% | | 23% | | 100% | | 23% | | |
| Resin | Area | | | | | | | | | | | | | | | | | |
| Portion | Resin | 60 | μm | 60 | μm | 60 | μm | 60 | μm | 20 | μm | 60 | μm | 60 | μm | 60 | μm | |
| | Portion | | | | | | | | | | | | | | | | | |
| | Thickness | | | | | | | | | | | | | | | | | |

| | | | | | | | | |
|---|---|---|---|---|---|---|---|---|
| Pattern | 4Φdot | 4Φdot | 4Φdot | 4Φdot | 4Φdot | 4Φdot | whole | 4Φdot |
| | | | inverted | | | | surface | |
| | | | layout | | | | | |

| Feeling | ◯ | | ◯ | | Δ | | ◯ | | ◯ | | ◯ | | Δ | | ◯ | | X | |
|---|---|---|---|---|---|---|---|---|---|---|---|---|---|---|---|---|---|---|
| Resistance to | 62 | kpa | 58 | kpa | 70 | kpa | 66 | kpa | 59 | kpa | 60 | kpa | 265 | kpa | 55 | kpa | 68 | kpa |
| Water Pressure | | | | | | | | | | | | | | | | | | |
| Concave/Convex | 325 | μm | 320 | μm | 295 | μm | 230 | μm | 130 | μm | 65 | μm | 0 | μm | 595 | μm | 180 | μm |
| Difference | | | | | | | | | | | | | | | | | | |

| | | | | | | | | | |
|---|---|---|---|---|---|---|---|---|---|
| Contact Area Ratio | 15% | 32% | 55% | 25% | 50% | 94% | 100% | 13% | 18% |
| Wearing Comfort | ◯ | ◯ | Δ | ◯ | Δ | X | X | ◯ | ◯ |
| Durability | | | | | | | | X | |

### INDUSTRIAL APPLICATION FIELD

When wearing clothes produced using the shape changeable textile fabric of the present invention, even if the wearer sweats, the moisture resulting from sweating is absorbed by the textile fabric and the shape of the water-absorbed textile fabric changes three-dimensionally, so that the area of contact between the moisture-containing textile fabric and the skin surface decreases. Consequently, the sticky feeling caused by sticking of the textile fabric onto the skin surface diminishes and the wearing comfort is improved remarkably. Further, upon drying, the shape of the textile fabric reverts to its original flat shape in a reversible manner and thus it is possible to give a good wearing comfort to the wearer.

Besides, the change in shape occurs reversibly without great impairment of the mechanical properties and color fastness inherent in the textile fabric, so when the textile fabric is applied to various closing uses, the resulting clothes are superior in comfortableness and can fully withstand practical use. Further, the textile fabric is easy of manufacture and is superior in versatility without placing any limitation on the fibers to be used.

Thus, the shape changeable textile fabric of the present invention is effectively applicable to, for example, inner wear, sports wear and rain coat.

1. A shape changeable textile fabric comprising a water-swelling layer as an outermost layer on at least one surface thereof, the water-swelling layer comprising a water-insoluble water-swelling resin applied in a pattern form.

2. A shape changeable textile fabric as set forth in claim 1, also having a waterproof continuous layer between the textile fabric and the outermost layer, the waterproof continuous layer comprising resin not having a water-swelling property.

3. A shape changeable textile fabric as set forth in claim 1, wherein the pattern of the outermost layer is a uniform pattern.

4. A shape changeable textile fabric as set forth in claim 1, wherein the pattern of the outermost layer is a sea-island pattern or a parallel line pattern.

5. A shape changeable textile fabric as set forth in claim 1, wherein the thickness of the outermost layer is 1-300 μm.

6. A shape changeable textile fabric as set forth in claim 1, wherein a total area of the resin portion in the outermost layer relative to the textile fabric is 5-90%.

7. A shape changeable textile resin as set forth in claim 1, wherein the degree of swelling of the water-insoluble water-swelling resin is 5-100%.

8. A shape changeable textile fabric as set forth in claim 2, wherein the waterproof continuous layer is a moisture-permeable waterproof continuous layer.

9. Clothing comprising the shape changeable textile fabric described in any of claims 1 to 8.
